(19) United States
(12) Patent Application Publication
(10) Pub. No.: US 2020/0087061 A1
(43) Pub. Date: Mar. 19, 2020

(54) Hygiene Product Receptacle, Deodorizer, and Storage System

(71) Applicant: Chandra R. Cole, Union, NJ (US)

(72) Inventor: Chandra R. Cole, Union, NJ (US)

(21) Appl. No.: 16/133,744

(22) Filed: Sep. 18, 2018

(51) Int. Cl. B65F 1/00; B65F 1/06; B65F 1/14

(52) U.S. Cl. CPC B65F 1/0026; B65F 2210/129; B65F 1/1426; B65F 1/06

(57) ABSTRACT

A system for discarding hygiene products is provided. The system includes a housing, including a first storage compartment configured to house one or more unused hygiene products, a second storage compartment configured to house one or more unused waste receptacle bags, one or more deodorizer compartments configured to house one or more deodorizing materials, and a receptacle compartment configured to house a waste receptacle bag, the waste receptacle bag being configured to house one or more discarded hygiene products. The system further includes the one or more deodorizing materials and the waste receptacle bag.

### CLAIM OF PRIORITY

This application is a United States non-provisional application and claims no priority to any previous United States patent application.

### FIELD OF THE EMBODIMENTS

This invention relates to disposal containers and, in particular, to a hygiene product disposal system incorporating a deodorizer, a waste receptacle, and a storage compartment.

### BACKGROUND OF THE EMBODIMENTS

Having a wide variety of uses, shapes, and designs, hygiene products are a necessity for a vast number of people and, in their many forms, are widely used. Because of this, many hygiene products are disposed of on a daily basis. Many of these products are merely thrown away in the regular trash, which can lead to undesired sights and odors.

For at least these reasons, a means for discretely disposing of hygiene products while containing undesirable odors and adding a pleasant fragrance is thus needed.

Examples of related art are described below:

U.S. Pat. No. 7,316,100 generally describes an integrated cutting system for a waste disposal device comprising a waste storage receptacle and a film cutting and sealing device. A cartridge containing a continuous length of film is positioned over the receptacle. The integrated cutting system further includes an activation mechanism operatively configured to alternatively engage a cutting device or a film sealing device capable oftwistably sealing the film of the cartridge when the film is dispensed from the cartridge. A selection mechanism is arranged to control the activation mechanism to either engage the cutting device while deactivating the film sealing device, or to engage the film sealing device while deactivating the cutting device. The cutting device comprises a blade positioned to sever the film from the cartridge.

U.S. Pat. No. 7,503,159 generally describes a waste disposal device that comprises a container having a lid. An externally accessible actuation mechanism comprising a rack and a pinion is connected to the lid, and is operatively configured to interface with a foot pedal. When the actuation mechanism is actuated by pressing the foot pedal, the lid opens, while the rack skips over the pinion. When the foot pedal is released, the rack engages the pinion, which in turn closes the lid and spins a cartridge of the device one revolution.

U.S. Pat. No. 7,708,188 generally describes a waste disposal device that comprises a container having a hamper. The hamper is insertable and removable through a movable door of the container.

U.S. Pat. No. 8,690,429 generally describes an improved receptacle liner bag is formed of two layers of thin flexible stretchable plastic sheets which are sealed along the sides and bottom, but are unsealed along the top of the bag. The sheets are die-cut to form a framed opening which defines a band between the sides and the top of the bag. When the bag is placed in the receptacle, the band may be disposed around the outside of the sides of the receptacle and stretched over the base of the receptacle so as to provide a hold-down for the bag in the receptacle. The sheets may be perforated along a line below the framed opening. The line, when opened, forms an auxiliary band which can be stretched over and placed behind a hinge of a lid of the receptacle to secure the back of the liner bag in the receptacle.

U.S. Pat. No. 8,905,988 generally describes a disposal-bag system attached to or formed at least partially by a disposable object (e.g., a diaper) includes a container that houses a disposal bag folded into a compact arrangement. The container is generally thin and flat and sized for storing the bag, and the bag is sized for holding the disposable object that the system is used with. And the bag is at least partially removable from the container so that the disposable object can be placed into it for disposal. In use, the container is opened, the bag is extended from the container and opened, the disposable object is grasped by reaching through the bag, the bag is inverted to now hold the disposable object, and the bag is closed and disposed of. In this way, the disposal-bag system provides a convenient, sanitary, and self-contained method of disposing of soiled diapers or other disposable objects.

U.S. Patent Publication No. 2006/0212015 generally describes a feminine disposal container. The container is a small box with a snap down lid made with a biodegradable cardboard or another material. Used tampons can be placed inside the container, the lid Snapped down, and the container disposed in the trash without mess or odor. In one embodiment, the container can be preformed and fresh tampons can be included in the container. In another embodiment, a conventional tampon applicator tube can be precut with perforations. Once the applicator is used, the applicator can be torn along the perforations and formed into the container. In several embodiments, different container types can be preformed or formed from conventional tampon containers.

U.S. Patent Publication No. 2012/0053549 generally describes a bag for use in collecting and disposing of a menstrual product includes first and second side walls having opposed side edges and end edge, respectively. Respective side and end edges are connected so that the bag defines a closed end and sides. The first side wall includes a second end edge not attached to the second side wall so as to define a bag open end opposite the bag closed end. The second side wall includes a closure portion that extends outwardly beyond the first side wall first end edge that is movable between an open configuration not covering the bag open end and a closed configuration covering the open bag end. The first and second side walls are constructed of a flexible material such that inside surfaces of the first and second side walls are movable through the open end to become exterior surfaces.

U.S. Patent Publication No. 2012/0299317 generally describes an apparatus for collecting and disposing pet waste that includes a biodegradable plastic bag and either one or two built-in disposable collection aids. The user grasps the lower closed end of the bag while also grabbing the built-in disposable collection aid. The bag is then inverted over the user's hand and forearm, providing protection from the pet waste and exposing the built-in collection aid. The collection aid's leading edge acts as a scoop and facilitates scooping up the pet waste. The bag is then inverted once again to its original position and optional handles are tied to close the bag.

U.S. Patent Publication No. 2015/0239664 generally describes a waste disposal apparatus, such as a waste disposal container or unit that is configured to receive used personal care products in a discreet and sanitary manner Instances of incontinence, menstruation or uncontrollable bodily functions can be a personal situation that is otherwise unknown to others. However, current receptacles available to dispose of used personal care products fail to provide for a hygienic, easily accessible and discreet that is designed for small spaces, such as a home bathroom or public restroom stall.

U.S. Patent Publication No. 2016/0068327 generally describes a wall-mounted receptacle with a sliding bottom allows removal of discarded articles without any need to manually contact the discarded articles or the interior surface or liner of the receptacle. A dispenser for plastic bags in which items to be discarded can be sealed or other single use items to be dispensed is also provided as part of the receptacle, preferably as an extended front portion. Items to be dispensed are protected from contact with contents of the receptacle by dispenser boxes and that protection can be enhanced by further sealing the volume containing the dispenser boxes.

U.S. Patent Publication No. 2017/0007473 generally describes a bag of thin plastic material shaped into a container having a closed end and an open end cut to provide two tying portions, and sides extending between the open and closed ends. The plastic material is of a color and has at least an antimicrobial agent, and has an imprinted design or pattern. The bag is of a size suitable for receiving a single product, such as a used feminine hygiene product, along with any other material in the use or replacement of such product by a user, in which the tying portions are tieable to seal the product within the bag. When a product is sealed in the bag by a user, the antimicrobial agent inhibits the growth of odor causing bacteria, the scent masks any odors, and the color and imprinted design assists to conceal or obfuscate any blood on a used feminine product in the bag.

U.S. Patent Publication No. 2017/0008261 generally describes a multi-layer thermoplastic film include a first film of thermoplastic material, a second film of thermoplastic material bonded to the first film, and an odor control component disposed between the first film and the second film. A method of manufacturing a multi-layer thermoplastic film coextruding a plurality of layers to form a first film, coextruding a plurality of layers to form a second film, disposing at least one odor control component on at least one of the first film and the second film, and bonding the first and second films together such that the at least one substance is disposed between the first film and the second film.

U.S. Patent Publication No. 2017/0224557 generally describes a pair of disposable light biodegradable plastic/natural rubber or latex-free gloves into the production and packaging of tampons and feminine pads; alternately, the Sani-Hanz gloves could be produced with a tampon pocket in the center for use in holding a tampon of the lady's choice. With one glove to be used during the insertion process, and one in the removal process, the Sani-Hanz would not only act as a barrier to prevent the user's hand and clothing from contamination by blood spatter and blood-borne pathogens, but also act as a handy disposal bag for both the tampon applicator (first glove) and the soiled tampon (second glove).

None of the art described above addresses all of the issues that the present invention does.

### SUMMARY OF THE EMBODIMENTS

According to an aspect of the present invention, a system for discarding hygiene products is provided. The system includes a housing, including a first storage compartment configured to house one or more unused hygiene products, a second storage compartment configured to house one or more unused waste receptacle bags, one or more deodorizer compartments configured to house one or more deodorizing materials, and a receptacle compartment configured to house a waste receptacle bag, the waste receptacle bag being configured to house one or more discarded hygiene products. The system further includes the one or more deodorizing materials and the waste receptacle bag.

It is an object of the present invention to provide the system for discarding hygiene products, wherein the first storage compartment is located on an upper portion of the housing.

It is an object of the present invention to provide the system for discarding hygiene products, wherein the first storage compartment includes one or more dividers for separating two or more hygiene products.

It is an object of the present invention to provide the system for discarding hygiene products, wherein at least one of the one or more deodorizer compartments is located in the second compartment.

It is an object of the present invention to provide the system for discarding hygiene products, wherein the system further includes a third compartment configured to temporarily close an opening of the waste receptacle bag.

It is an object of the present invention to provide the system for discarding hygiene products, wherein at least one of the one or more deodorizer compartments is located in the third compartment.

It is an object of the present invention to provide the system for discarding hygiene products, wherein the system further includes a door coupled to the third compartment, wherein opening the door grants a user access to the opening of the waste receptacle bag.

It is an object of the present invention to provide the system for discarding hygiene products, wherein the system further includes a clamping mechanism configured to clamp closed a portion of the waste receptacle bag, preventing unwanted odors from escaping.

It is an object of the present invention to provide the system for discarding hygiene products, wherein the clamping mechanism further includes an opening mechanism configured to enable a user to unclamp the waste receptacle bag.

It is an object of the present invention to provide the system for discarding hygiene products, wherein at least one of the one or more deodorizing materials include a deodorizing crystal.

It is an object of the present invention to provide the system for discarding hygiene products, wherein the system further includes a securing mechanism configured to secure the housing to a surface.

It is an object of the present invention to provide the system for discarding hygiene products, wherein the securing mechanism is a suction piece.

It is an object of the present invention to provide the system for discarding hygiene products, wherein the securing mechanism is a receptor for a nail or screw.

It is an object of the present invention to provide the system for discarding hygiene products, wherein the system further includes a cap configured to cover an opening of the waste receptacle bag.

It is an object of the present invention to provide the system for discarding hygiene products, wherein the cap is removable, enabling access to the opening of the waste receptacle bag.

### BRIEF DESCRIPTION OF THE DRAWINGS

FIG. 1 shows a perspective view of a hygiene product disposal storage system with interior and exterior components visible, according to an embodiment of the present invention.

FIG. 2 shows a side view of the hygiene product disposal storage system with interior and exterior components visible, according to an embodiment of the present invention.

FIG. 3 shows a perspective view of an upper portion of the hygiene product disposal storage system with interior and exterior components visible, according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

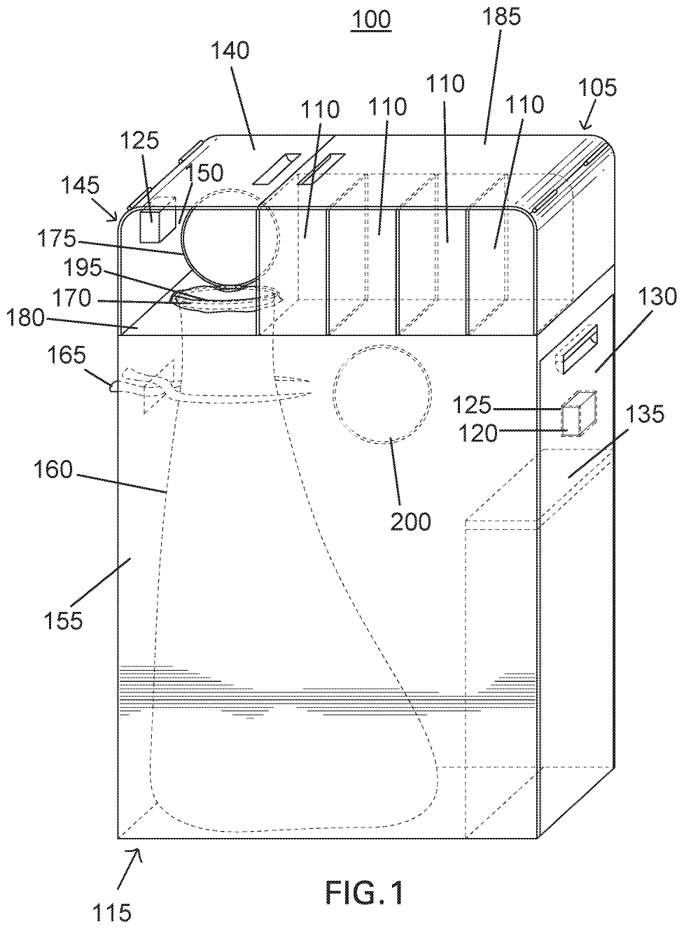

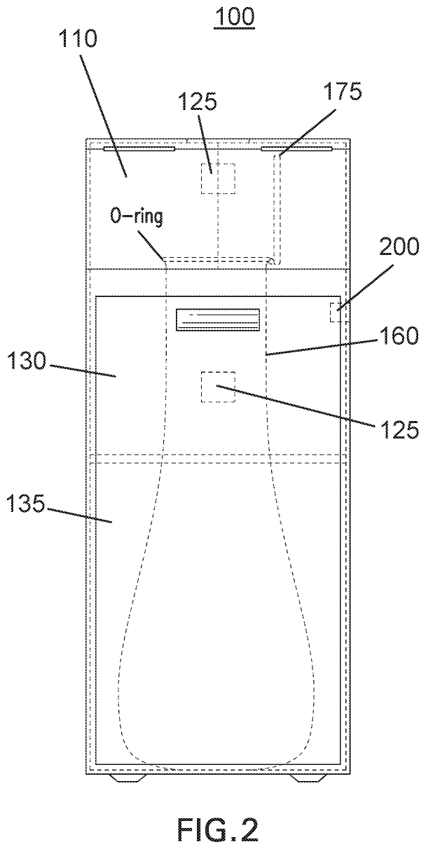

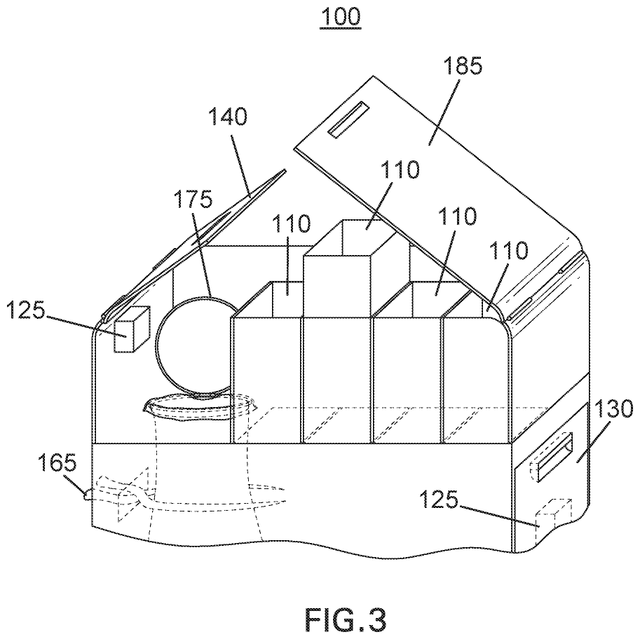

Referring now to FIGS. 1-3, a perspective view (FIG. 1), a side view (FIG. 2), and a perspective view of an upper portion (FIG. 3) of a hygiene product disposal system 100 showing interior and exterior components are illustratively depicted, in accordance with an embodiment of the present invention.

According to an embodiment, the hygiene product disposal system 100 is a deodorizing waste receptacle system used for the disposal of any type of hygiene products with a separate compartment 105 designed for the storage of clean products. According to an embodiment, the compartment 105 includes one or more sub-compartments 110 for storing clean hygiene products of one type or multiple types. According to an embodiment, one or more of the sub-compartments 110 are adjustable in shape. According to an embodiment, the sub-compartments 110 are separated using adjustable slots. It is noted, however, that other forms of adjustable separators may also be used, while maintaining the spirit of the present invention.

According to an embodiment, the hygiene product disposal system 100 may be used for the storage and disposal of feminine hygiene products, incontinence products, bandages, and/or other personal care items including, e.g., any kind of biological and non-biological waste products which may emit offensive odor. According to an embodiment, the system 100 serves as a storage unit, room deodorizer, and waste receptacle system. It is unique in its multipurpose functionality.

The system 100 includes a housing 115. According to an embodiment, the storage compartment 105 of the system 100 is located at a top portion of the housing 115. According to an embodiment, the housing 115 has a wide area at the top portion, affording ready accessibility to feminine hygiene products, bandages, incontinence products, wipes, condoms, sponges, underwear, and/or any other suitable type of product that can be stored. According to an embodiment, the stored products are located in segregated sub-compartments 110 to ensure that the stored products are not contaminated by the used products.

According to an embodiment, the storage unit 105 on the top is accessed from door 185 on the top of the housing 115. The storage unit 105 can be opened by lifting the door 185 and accessing the stored products (as shown in FIG. 3). According to an embodiment, the sub-compartments 110 are separated by dividers 190. According to an embodiment, the dividers 190 are movable dividers. This enables users to customize the space allotted for each sub-compartment 110.

According to an embodiment, the system 100 includes at least one deodorizer 120. According to an embodiment, the system 100 includes two deodorizers 120, although it is noted that any suitable number of deodorizers 120 may be used while maintaining the spirit of the present invention. According to an embodiment, there are two deodorizer compartments 125 in the unit that house the deodorizing material 120. The deodorizing material 120 may be a deodorizing crystal, a deodorizing spray, and/or any other suitable form of deodorizing material 120. According to an embodiment, a deodorizing compartment 125 and deodorizing material or materials 120 are located inside of a door 130 on a side of the housing 115 of the (where, according to an embodiment, a storage compartment 135 for unused bags is located). According to an embodiment, a deodorizing compartment 125 and deodorizing material 120 are located under an opening 140 to the waste compartment 145 (also known as the receptacle portion).

According to an embodiment, the deodorizer 120 not only deodorizes the system 100 and the room in which the system 100 is located by emitting a pleasant smelling odor, it also absorbs unwanted odors, giving any room in which the system 100 is located a scent makeover. According to an embodiment, the level of scent can be adjusted by placing deodorizers 120 in the front and/or the back on the housing 115 depending on a user's tolerance and desire.

According to an embodiment, the system 100 includes a receptacle portion 145. The receptacle portion 145 of the system 100 provides a compartment 150 having a segregated waste portion 155 situated underneath. According to an embodiment, the segregated waste portion 155 houses a waste receptacle bag 160. According to an embodiment, the system 100 seals the waste receptacle bag 160 with a clamped claw 165 between disposals to minimize the escape of undesirable odors. It is noted, however, that other methods of clamping the waste receptacle bag 160 closed may also be used while maintaining the spirit of the present invention. According to an embodiment, the waste receptacle bag 160 includes an elastic band 170 across the top and is capped 175 to stay in place at the top of the separation wall 180. According to an embodiment, the cap 175 is removable, enabling access to the opening of the waste receptacle bag 160. According to an embodiment, the system 100 is easily emptied by pulling the bag 160 out from the housing 115 through door 130.

According to an embodiment, the waste receptacle compartment 150 is accessed from door 140 at the top of the housing 115. According to an embodiment, the waste receptacle bags 160 are fitted around an “O”-shaped opening and an “O”-shaped ring 195 is placed on top to keep the bag 160 in place. According to an embodiment, the “O”-shaped ring 195 has rubber inside to ensure that the fit of the bag 160 is tight around the edges and simply lifts up and down by use of a hinge and does not separate from the unit. It is noted, however, that any suitable shape may be used for the opening and the ring 195, while maintaining the spirit of the present invention.

According to an embodiment, the user places their hand in the bag 160 to ensure that the bag has expanded enough for refuse to be deposited. According to an embodiment, there is the clamp/claw system 165 in place on the side of the housing 115. According to an embodiment, an end of the claw/clamp system 165 is located on the outside of the housing 115 and can be opened by a lever which presses the edges together which are connected by a spring. This causes the claw/clamp on the inside to open allowing the bag 160 to be placed in as well as refuse to be inserted. Once the refuse is inserted, the clamp 165 is released and it tightens around the top of the bag 160, preventing odor from escaping.

According to an embodiment, when changing the bag 160, door 130 is opened. The “O” ring 195 is lifted, the elastic is dislodged around the “O” and the bag 160 is simply pulled out, tied and discarded. The access door 130 on the back of the unit is closed, and another bag 160 is inserted through the top and the process repeats itself. According to an embodiment, on the inside of the door 130 is a pocket for storing additional bags and a pocket for storing additional deodorizing materials 120, making the system 100 self-contained for convenience. According to an embodiment, the pockets are rigid. According to an embodiment, the pockets are stretchable.

According to an embodiment, the system includes a securing mechanism 200 for securing/anchoring the system to a surface. According to an embodiment, the securing mechanism is a suction piece. It is noted, however, that any suitable securing mechanism 200 may be used, such as a receptor for a nail or a screw (as shown in FIG. 2), while maintaining the spirit of the present invention.

When introducing elements of the present disclosure or the embodiment(s) thereof; the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for discarding hygiene products, comprising:
a housing, including:
a first storage compartment configured to house one or more unused hygiene products;
a second storage compartment configured to house one or more unused waste receptacle bags;
one or more deodorizer compartments configured to house one or more deodorizing materials; and
a receptacle compartment configured to house a waste receptacle bag, the waste receptacle bag being configured to house one or more discarded hygiene products;
the one or more deodorizing materials; and
the waste receptacle bag.

2. The system as recited in claim 1, wherein the first storage compartment is located on an upper portion of the housing.

3. The system as recited in claim 1, wherein the first storage compartment includes one or more dividers for separating two or more hygiene products.

4. The system as recited in claim 1, wherein at least one of the one or more deodorizer compartments is located in the second compartment.

5. The system as recited in claim 1, further comprising a third compartment configured to conceal an opening of the waste receptacle bag.

6. The system as recited in claim 5, wherein at least one of the one or more deodorizer compartments is located in the third compartment.

7. The system as recited in claim 5, further comprising a door coupled to the third compartment, wherein opening the door grants a user access to the opening of the waste receptacle bag.

8. The system as recited in claim 1, further comprising a clamping mechanism configured to clamp closed a portion of the waste receptacle bag.

9. The system as recited in claim 8, wherein the clamping mechanism further includes an opening mechanism configured to enable a user to unclamp the waste receptacle bag.

10. The system as recited in claim 1, wherein at least one of the one or more deodorizing materials include a deodorizing crystal.

11. The system as recited in claim 1, further comprising a securing mechanism configured to secure the housing to a surface.

12. The system as recited in claim 11, wherein the securing mechanism is a suction piece.

13. The system as recited in claim 11, wherein the securing mechanism is a receptor for a nail or screw.

14. The system as recited in claim 1, further comprising a cap configured to cover an opening of the waste receptacle bag.

15. The system as recited in claim 14, wherein the cap is removable, enabling access to the opening of the waste receptacle bag.
